(19) United States
(12) Patent Application Publication
(10) Pub. No.: US 2002/0128880 A1
(43) Pub. Date: Sep. 12, 2002

(54) Information management device and information management system

(75) Inventor: Tatsuya Kunikiyo, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 09/949,765

(22) Filed: Sep. 12, 2001

(30) Foreign Application Priority Data
Mar. 12, 2001 (JP) 2001-068609

(51) Int. Cl. G06F 17/60

(52) U.S. Cl. 705/4

(57) ABSTRACT

An information management device/information management system are provided which are used by a party which runs a business of storing and managing electronic data entrusted by clients. The information management device/information management system facilitate quick compensation to the clients when the deposited information has been damaged in some way in the absence of any fault of the depositary, allow the clients to be quickly informed of the value of the damage, and enable the depositary to utilize the deposited information for its own business. Under circumstances where a client has settled an accident insurance contract for the deposited information with an insurance company, a server (SV) of the depositary stores information about the accident insurance money to be paid to the client when the deposited information is damaged. When the deposited information is actually damaged, the server (SV) assesses the extent of the damage, calculates the amount of the accident insurance money, and reports it to the depositor and the insurance company. Also, the deposited information includes information about spending tendencies of the depositors, and information about general tendencies of consumers is generated on the basis of the spending tendency information and presented to the depositors.

### BACKGROUND OF THE INVENTION

1. Field of the Invention

The present invention relates to an information management device and an information management system which are used by an information management business firm whose business objects include storing and managing electronic data deposited from clients in a storage device.

2. Description of the Background Art

An information management service is now in practice which stores and manages various kinds of electronic data deposited by the clients by using server computers having large-capacity hard disks or other storage devices. Firms which run such information management service, sometimes called “SSPs (Storage Service Providers),” provide their clients, e.g. enterprises, individuals, etc. with depositories for storing electronic data which cannot be accommodated in the clients' terminals.

Recent developments in information communication techniques such as the Internet are allowing users to download in their terminals every kind of electronic data, such as sounds, moving pictures, still pictures, texts, numerical data like statistics, and software like games. Therefore individuals who frequently download such data and organizations which need to store large amounts of electronic data often suffer lack of storage capacity of storage devices in their own terminals. They therefore deposit electronic data with such information management firms (hereinafter referred to as depositary).

Herein the terminals of clients include every kind of terminals which are connectable to servers of the depositaries through networks, such as personal computers, BS digital TVs, cellular phones, game machines, etc.

At present, the servers used by the depositaries are generally connectable to such terminals of the clients through networks, e.g. the Internet, and they form an information management system together. In this information management system, the clients or authorized workers in the depositaries, e.g. system managers, can rewrite or read deposited electronic data as required.

In the conventional information management business, when information deposited at the depositary is damaged in some way without any fault on the depositary party, e.g. when deposited information kept at the depositary is destroyed or stolen by a criminal like a cracker, the client is not paid for the damage. The client cannot be quickly informed of the value of the damage, either.

Further, conventional depositaries only store and manage deposited information, without effectively utilizing the deposited information for their own businesses.

### SUMMARY OF THE INVENTION

According to a first aspect of the present invention, an information management device comprises: first storage means for storing deposited information which is electronic data deposited by a client; second storage means for storing insurance money defining information about accident insurance money which, when the deposited information is damaged, is paid as accident compensation to the client on the basis of the extent of the damage; and control means for controlling the first and second storage means, wherein the control means calculates the amount of the accident insurance money to be paid for the damage on the basis of the insurance money defining information.

Preferably, according to a second aspect, in the information management device, the control means periodically examines the deposited information to detect the damage.

According to a third aspect of the present invention, an information management system comprises: the information management device of the first aspect; a terminal of an insurance company which has a contract for the accident insurance money with the client, the terminal of the insurance company being connected to the information management device through a network and capable of conducting electronic commerce; and a terminal of a financial institution where the client has an account, the terminal of the financial institution being connected to the terminal of the insurance company through the network and capable of conducting electronic commerce, wherein the accident insurance money is paid from the terminal of the insurance company into the account of the client in the terminal of the financial institution through electronic commerce.

According to a fourth aspect of the present invention, an information management device comprises: storage means for storing deposited information which is electronic data deposited from a plurality of clients as consumers; and control means for controlling the storage means, wherein the deposited information comprises information about spending tendencies of the individual clients, and the control means is capable of presenting the plurality of clients with consumer information about a general tendency of consumers generated on the basis of the information about spending tendencies.

Preferably, according to a fifth aspect, in the information management device, the information about spending tendencies is information about products and/or services which the individual clients demand, and the consumer information is information about ranking of the products and/or services which the plurality of clients demand and which is obtained by adding up the information about spending tendencies.

Preferably, according to a sixth aspect, in the information management device, the storage means also stores another piece of deposited information which is electronic data deposited by another client who is a product and/or service provider, and that another piece of deposited information comprises advertising information about products and/or services which the product and/or service provider deals with, and wherein, in response to a request from at least one of the plurality of clients as consumers, the control means presents the advertising information to the at least one of the clients.

According to the first aspect of the present invention, the information management device, which stores information deposited by clients, calculates the amount of accident insurance money to be paid for damage to the deposited information on the basis of the insurance money defining information. Therefore the clients can be quickly informed of the estimated amount of the accident insurance money, or the value of the loss. Further, the insurance company can utilize the amount of the accident insurance money calculated by the information management device when carrying out its own damage assessment and accident insurance money calculation. This facilitates quick calculation of the amount of the accident insurance money and quick payment of the accident insurance money to the client.

According to the second aspect, the deposited information is periodically checked for damage. The damage to the deposited information can therefore be found in early stages to suppress the amount of loss.

According to the third aspect, the accident insurance money is paid into an account of the client by electronic commerce. This enables quick payment of the accident insurance to the client.

According to the fourth aspect, the information management device presents a plurality of clients with consumer information about a general consumer tendency generated on the basis of the spending tendency information about individual clients. The party who sets the information management device can thus utilize the deposited information to generate the consumer information and win as new clients the consumers who desire to know the consumer information. Moreover, the plurality of clients as consumers can consider what products or services to purchase in the future by referring to the consumer information.

According to the fifth aspect, ranking information about products and/or services which a plurality of clients demand is presented to the clients as consumer information, which allows the plurality of clients as consumers to consider what products or services to buy in the future while referring to the products and services many other clients demand.

According to the sixth aspect, the information management device presents advertising information from a product and/or service provider as required by a plurality of clients as consumers. This allows the plurality of clients as consumers to consider what products or services to buy in the future while referring to the advertising information. The party who sets the information management device can receive an advertising fee from the other client or the product and/or service provider for providing it with opportunities of presenting its advertising information to consumers.

An object of the present invention is to provide an information management device and an information management system which facilitate quick compensation to the clients when the deposited information has been damaged in some way in the absence of fault of the depositary, which allow the clients to be quickly informed of the value of damage, and which enable the depositary to utilize the deposited information for its own business.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an information management system according to a preferred embodiment of the present invention;

FIG. 2 is a diagram showing the structure of depositary's server;

FIG. 3 is a diagram showing an example of a menu provided from the depositary's server;

FIG. 4 is a flow chart showing a procedure for registering/altering membership information and deposited information;

FIG. 5 is a flow chart showing a procedure for delivery of the deposited information;

FIG. 6 is a flow chart showing a procedure for electronic commerce with the depositary;

FIG. 7 is a flow chart showing a procedure for accident insurance transactions;

FIG. 8 is a flow chart showing a procedure for adding up results of a questionnaire sent back from depositors as consumers and sending the results to the consumers;

FIG. 9 is a diagram showing a questionnaire distributed to depositors as consumers;

FIG. 10 is a diagram showing an example of the added results; and

FIG. 11 is a diagram showing advertising information deposited by a depositor as a company.

### DESCRIPTION OF THE PREFERRED EMBODIMENTS

A preferred embodiment of the present invention realizes an information management system in which, under circumstances where a client has previously settled an accident insurance contract with an insurance company on deposited information against damage occurring to the deposited information in the absence of any fault on the depositary party, a server of the depositary party stores, as well as the deposited information, insurance money defining information about the accident insurance money to be paid to the client when the deposited information is damaged, where when the deposited information is actually damaged, the server assesses the extent of the damage and calculates the amount of the accident insurance money on the basis of the assessment and the insurance money defining information so that the client can quickly be informed of the value of the loss and so that the accident insurance money can be quickly paid to the client.

It also realizes an information management system which enables the depositary party to utilize the deposited information for its own business, where the depositary party includes information about spending tendencies of individual clients as consumers in the deposited information, generates consumer information about general tendencies of the consumers on the basis of the spending tendency information, and presents the consumer information to the clients as consumers.

<Structure of Deposited Information Management System>

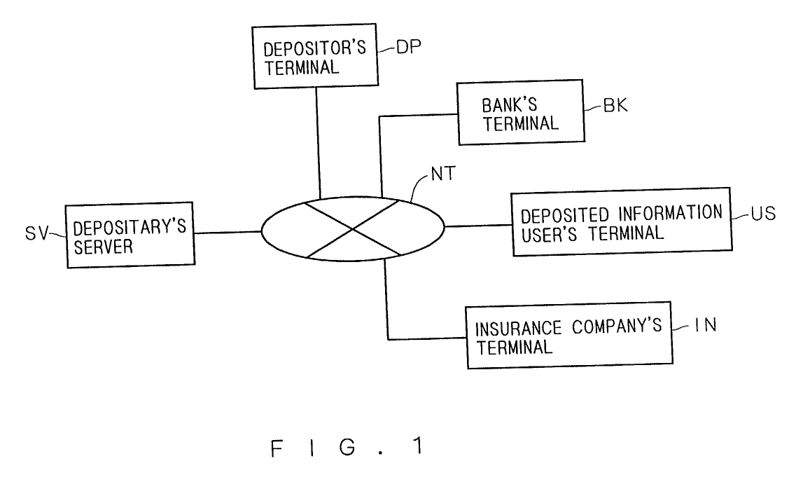

FIG. 1 is a diagram showing an information management system according to a preferred embodiment of the present invention. As shown in FIG. 1, this information management system comprises a terminal DP of a depositor who deposits information, a server SV of a depositary who keeps the deposited information, a terminal US of a deposited information user who has been allowed by the depositor to use the deposited information, a terminal IN of an insurance company who made an accident insurance contract with the depositor against damage caused by e.g. attack by a cracker to the deposited information in the absence of any fault of the depositary, and a terminal BK of a bank where the depositor has an account. The depositor's terminal DP, depositary's server SV, deposited information user's terminal US, insurance company's terminal IN and bank's terminal BK are all connected to each other through a network NT such as the Internet.

The depositor's terminal DP, depositary's server SV, deposited information user's terminal US, insurance company's terminal IN and bank's terminal BK all can be any terminals which are connectable to the depositary's server SV through the network: they can be, of course, office computers or personal computers, or BS digital TVs, cellular phones, game machines, etc.

The transmission medium in the network NT can be any of telephone line, optical fiber line, cable TV line, satellite broadcast line, radio, etc.

In this information management system, the depositor sends various kinds of electronic data stored in depositor's terminal DP as information to be deposited in the depositary's server SV through the network NT. The depositary then stores the deposited information in a storage device in the server.

Now, the depositors can be roughly classified into two groups: individuals as consumers and organizations such as companies, firms, etc. which provide products and/or services. Although, of course, they can be classified in other ways, this specification adopts this way of classification.

When the depositor is an individual, the deposited information may be, as stated earlier, electronic data such as sounds, moving pictures, still pictures, texts, numerical data like statistics, or software like games. Needless to say, such electronic data includes not only downloaded data but also data which the depositor or others have created or composed.

Other examples of the deposited information include information which is related to electronic commerce conducted by individuals, such as electronic data representing securities (e.g. checks, drafts, stock certificates, credit certificates, etc.), electronic data representing documents (e.g. contents-certified mails, contracts, bills, receipts, driver's licenses, health insurance cards, invoices, various insurance policies, patent certificates, copies of family registration certificates, copies of register books, etc.), and electronic money.

When the depositor is an organization, the deposited information may be the same kinds of information as those recited above about individuals. More specifically, for example, it may be business transaction information, instruments/memorandums, accounting information, personnel information, patent information, information about working conditions, information about job training, administrative information, materials purchase information, information about legal affaires, business information, in-house or external documents, proceedings, etc.

When the organization is one which deals with science technologies, the deposited information may include electronic data such as numerical data about science technologies. When the organization is one which provides medical services, e.g. a medical corporation, the deposited information may include electronic data representing medical charts about patients' health conditions.

The deposited information can be in any format, while the deposited information as shown above is generally described in various known formats, such as MPEG (Moving Picture Experts Group) 2, MPEG 4, Postscript, PDF, text format, etc. The deposited information may be in a compressed form, with its capacity compressed by some known software tool.

<Structure of Depositary's Server>

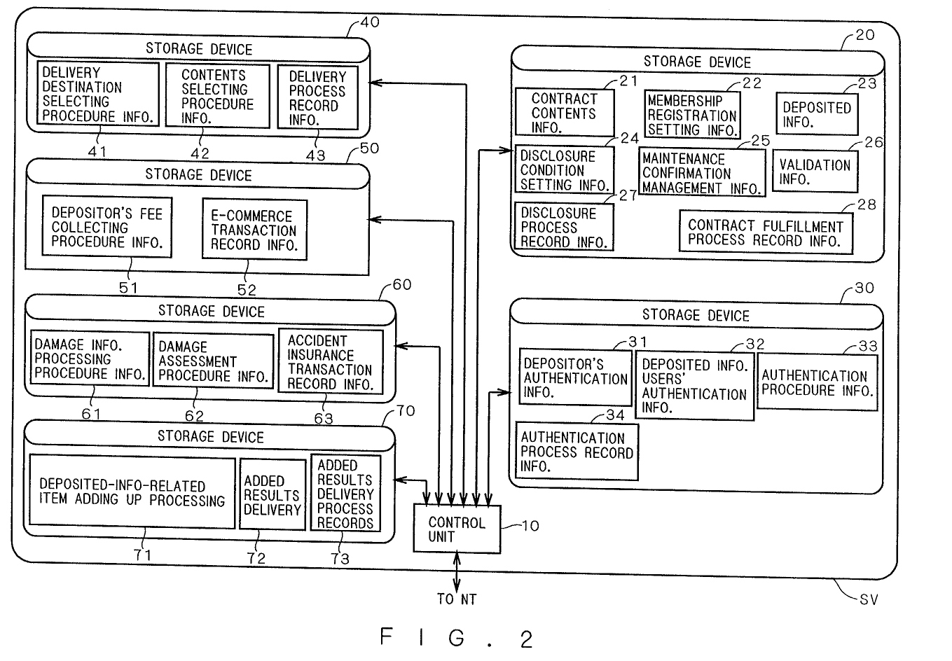

FIG. 2 is a diagram showing the structure of the depositary's server SV. The depositary's server SV comprises a control unit 10 and storage devices 20, 30, 40, 50, 60 and 70, where the control unit 10 controls the storage devices and performs data input/output in and from the storage devices.

The control unit 10 is a CPU (Central Processing Unit) to which ROM (Read Only Memory), RAM (Random Access Memory) etc. are connected, which is a functional part operating according to a given software program. The control unit 10 is connected to the network NT through an input/output interface (not shown) to exchange information with terminals connected through the network NT.

Each of the storage devices is a rewritable storage device, such as a hard disk, CD-RW (Compact Disk ReWritable), etc. While this server uses six storage devices 20, 30, 40, 50, 60 and 70, the six storage devices indicate that the contents stored are divided into six functions; they do not show that the server actually requires six storage devices. That is to say, one or a plurality of actual storage devices, e.g. hard disks, may be prepared for each of the storage devices 20, 30, 40, 50, 60, 70, or some or all of the storage devices 20, 30, 40, 50, 60, 70 may be constructed as one storage device.

The contents of the information stored in the storage devices 20, 30, 40, 50, 60 and 70 are now described.

The storage device 20 stores the deposited information and information concerning the deposited information. While the deposited information has been already described, the information concerning the deposited information includes various information required when the depositor deposits information, and records of various processes.

Specifically, for example, the information concerning the deposited information includes: information about the contents of the deposit contract settled between the depositary and the depositor; information about depositor's address, name, and where the depositary can contact the depositor; information about a password used when the depositor accesses the server SV and a membership number assigned from the depositary; information required to conduct electronic commerce with the depositary (information about depositor's bank account number, credit card number, electronic money, etc.); information about deposited information users who are allowed to use the deposited information; information about the range of the information which can be disclosed to the deposited information users; and information about payments for the deposit contract, past disclosure processings, etc.

For example, when the depositor is a patient and the deposited information is an electronic medical chart of the patient, the deposit information users may include a physician, hospital, etc. who use the electronic medical chart.

The contract contents information storage region 21 in the storage device 20 is a region for storing the information about the contents of the deposit contract settled between the depositary and the depositor. For example, the contents of the deposit contract may include: the storage capacity to be provided (e.g. X terabytes), duration of the deposit, contracted price, frequency of check to the deposited information for virus infection or data alteration.

The membership registration setting information storage region 22 in the storage device 20 is a region for storing the information such as depositor's address, name, where to contact, password, membership number, etc.

The deposited information storage region 23 in the storage device 20 is a region for storing the deposited information, or various electronic data as shown above.

The disclosure condition setting information storage region 24 in the storage device 20 is a region for storing the information about the deposited information users who are allowed by the depositor to see the deposited information, such as their addresses, names, where to contact, etc.

The maintenance confirmation management information storage region 25 in the storage device 20 is a region for storing management information as to whether the contract money defined by the deposit contract or the maintenance fee are paid through electronic commerce.

The validation information storage region 26 in the storage device 20 is a region for storing management information as to whether the contents of the maintenance confirmation management information storage region 25 are valid or invalid, which is provided to prevent the depositor etc. from unfairly altering the contents of the contract money or maintenance fee in the maintenance confirmation management information storage region 25.

The disclosure process record information storage region 27 in the storage device 20 is a region for storing information about records of processes in which the depositor, deposited information user, or system manager in the depositary read or rewrote the deposited information.

The contract fulfillment process record information storage region 28 in the storage device 20 is a region for storing information about records of various processes conducted according to the contents of the contract (e.g. the aforementioned periodic check service to the deposited information).

Now, in order to prevent parties who have no right to access the deposited information from reading and rewriting the deposited information, the server SV performs authentication procedure. The storage device 30 is used to store information concerning the authentication of the depositor and deposited information users. The information includes authentication information for checking whether the depositor or deposited information user is authentic and information about the authentication process.

The authentication information for checking whether the depositor or deposited information user is authentic may include: electronic data representing depositor's or deposit information user's autograph, fingerprint, voiceprint, retinal print, seal (stamp), and electronic data representing depositor's or deposited information user's driver's license, passport, health insurance card, etc.

The information about authentication process may include authentication procedure information describing the procedure of the authentication performed in the control unit 10, and information about past authentication process records.

The depositor's authentication information storage region 31 in the storage device 30 is a region for storing the authentication information for checking whether the depositor is authentic.

The deposited information users' authentication information storage region 32 in the storage device 30 is a region for storing the authentication information for checking whether the deposited information user is authentic.

The authentication procedure information storage region 33 in the storage device 30 is a region for storing information about the procedure of the authentication performed in the control unit 10.

The authentication process record information storage region 34 in the storage device 30 is a region for storing information about records of past authentication processes.

Part or all of the deposited information may be set to be periodically delivered to predetermined parties according to intention of the depositor (to the depositor or part or all of the deposited information users). In this case, the server SV selects contents of the deposited information and makes delivery to the parties at times predetermined by the contract.

The storage device 40 is used to store information concerning the delivery to predetermined parties. The information concerning the delivery includes: information about the procedure for selecting destinations of the delivery, information about the procedure for selecting contents to be delivered, and information about records of past delivery processes.

The delivery destination selecting procedure information storage region 41 in the storage device 40 is a region for storing the information about the procedure for selecting destinations of the delivery performed in the control unit 10.

The contents selecting procedure information storage region 42 in the storage device 40 is a region for storing the information about the procedure for selecting the delivered contents performed in the control unit 10.

The delivery process record information storage region 43 in the storage device 40 is a region for storing information about records of past delivery processes.

The deposit contract fee is collected by electronic commerce between the depositary and the depositor. More specifically, the fee of the deposit contract is collected by electronic commerce between the server SV and the terminal BK of the bank where the depositor has an account.

The storage device 50 is used to store information about the electronic commerce. The electronic commerce information includes information about the procedure for collecting fees from the depositor.

The depositor's fee collecting procedure information storage region 51 in the storage device 50 is a region for storing information about the procedure for collecting fees according to the deposit contract performed in the control unit 10.

The electronic commerce transaction record information storage region 52 in the storage device 50 is a region for storing information about records of past electronic commerce transactions.

In the present invention, the depositary's server SV stores insurance money defining information about the accident insurance money to be paid to the client when the deposited information is damaged without any fault of the depositary, and the server SV assesses the loss when the deposited information has been actually damaged. The server SV calculates the amount of the accident insurance money on the basis of the assessment and the insurance money defining information and reports the calculated results to the terminals of the insurance company and the depositor.

For example, the insurance money defining information includes information as to what amount of accident insurance money is to be paid for what gigabytes of damage in the storage region where the deposited information is stored, and information as to what amount of accident insurance money is to be paid when the deposited information is infected by a virus.

It is assumed here that the accident insurance contract for the deposited information has been previously settled between the client and the insurance company and that the depositary has previously obtained the insurance money defining information from the insurance company. The accident insurance contract for the deposited information may be established between the depositary and the insurance company as a service from the depositary to the depositor as a client, in which case the client is the insured.

The following methods are possible as the method of detecting and assessing the damage, for example: the depositary's server SV periodically monitors the amount of data of the deposited information, and when detecting that the amount of data has been decreased without depositor's intention, it judges that the data has been erased or tampered with and calculates the amount of damage according to the amount of loss, or when detecting that the amount of data has been increased without depositor's intention, it judges that the data has been added or tampered with and calculates the amount of damage according to the amount of increase; or the depositary's server SV periodically applies a known virus check software program to the deposited information to detect virus and calculates the value of the damage according to a value predetermined for the virus type.

The assessment of the damage may of course be performed on the basis of, as well as the aforementioned periodic check, a report to the depositary from the depositor who has noticed some trouble of the data.

As explained above, when a damage has occurred, the server SV assesses the damage and calculates the amount of the accident insurance money on the basis of the assessment and the insurance money defining information, so that the depositor as a client can quickly know the estimated value of the accident insurance money, or the value of the damage.

The amount of the accident insurance money calculated by the server SV is reported also to the insurance company and then the insurance company can carry out its own damage assessment and accident insurance calculation while referring to the amount of the accident insurance money calculated by the server SV. Or, when the insurance company admits that the amount of the accident insurance money calculated by the server SV is reliable enough, it can adopt the as-calculated value as the insurance money.

In this way, the insurance company is informed of the amount of accident insurance money calculated by the server SV, so that the insurance company can utilize the information in performing damage assessment and accident insurance money calculation, which facilitates quick calculation of the amount of the accident insurance money and quick payment of the accident insurance money to the depositor as a client.

Further, when the depositary's server SV is designed to periodically monitor the amount of data of the deposited information or to periodically apply examination such as a virus check, damage to the deposited information can be found in early stages to suppress the amount of loss.

When a damage has occurred to the deposited information, the payment of the accident insurance money to the client is made through electronic commerce between the insurance company and the depositor. More specifically, the payment of the accident insurance money is made by electronic commerce between the insurance company's terminal IN and the terminal BK of the bank where the depositor has an account.

That is to say, in this invention, the terminal BK of the bank where the depositor has an account, which is capable of electronic commerce, and the insurance company's terminal IN, which is also capable of electronic commerce, are both connected to the depositary's server SV through the network NT. Where the accident insurance money is paid into the depositor's account in the bank's terminal BK from the insurance company's terminal IN through electronic commerce. The accident insurance money is thus quickly paid to the client.

The storage device 60 stores information concerning the accident insurance transactions. The information concerning the accident insurance transactions includes: information about the procedure for grasping and recording the conditions of information leakage, malfunction of the storage device, destruction of the data etc. in the event of damage to the deposited information; information about the procedure for the assessment of the amount of damage and the amount of accident insurance money; and information about records of past accident insurance transactions.

The damage information processing procedure information storage region 61 in the storage device 60 is a region for storing the information about the procedure for grasping and recording damage conditions of the deposited information performed in the control unit 10.

The damage assessment procedure information storage region 62 in the storage device 60 is a region for storing the information concerning the procedure for the assessment of the amount of accident insurance money performed in the control unit 10.

The accident insurance transaction record information storage region 63 in the storage device 60 is a region for storing the information about records of past accident insurance transactions.

When the depositor is a consumer, information about spending tendencies of the individual depositors may be included in the deposited information (information about spending, such as what products and/or services they demand, what products and/or services they are planing to purchase, what complaints they have about current products and/or services, etc.). More specifically, when the depositor deposits information, the depositary issues a questionnaire about spending tendencies and includes the answers to the questionnaire in the deposited information. Of course, the cost of the storage capacity for the questionnaire is assigned to the depositary so that the storage capacity which the depositor contracts will not be reduced.

The depositary produces consumer information about general tendencies of consumers on the basis of the answers to the questionnaire from a plurality of depositors (e.g. “ranking information about products consumers now demand most”), which can be sent to the depositors.

Then the depositary can win as new clients the consumers who desire to know the consumer information. In the case of a depositor who has already settled a deposit contract, the depositor can consider what products or services to purchase in the future by referring to the consumer information.

When the depositors also include a company or firm who provides products and/or services and the deposited information includes advertising information about products and/or services it deals with, the depositary can present the advertising information as required by depositors as consumers who referred to the consumer information. More specifically, the depositary provides depositors as consumers with access to the advertising information deposited by the company by setting links in the consumer information to the advertising information deposited by the company.

This allows the depositors as consumers to refer to the advertising information to consider what products or services to purchase in the future. Further, the depositary can receive fees from the other party or the depositor as a company for providing it with opportunities to present its advertising information to the consumers.

The storage device 70 is used to store information about procedures of adding up the spending tendency information about individual depositors as consumers and delivering the added up results as a deposited-information-related item. The information about the adding up and delivery of the deposited-information-related item includes information about the procedure for adding up the deposited-information-related item, information about the procedure for delivering the added results, and information about records of past added results delivery transactions.

The deposited-information-related item adding up information storage region 71 in the storage device 70 is a region for storing the information about the procedure for adding up the deposited-information-related item performed in the control unit 10.

The added results delivery procedure information storage region 72 in the storage device 70 is a region for storing the information about the procedure for delivering the added results performed in the control unit 10.

The added results delivery process record information storage region 73 in the storage device 70 is a region for storing the information about records of past added results delivery transactions.

<Various Processings in Depositary's Server>

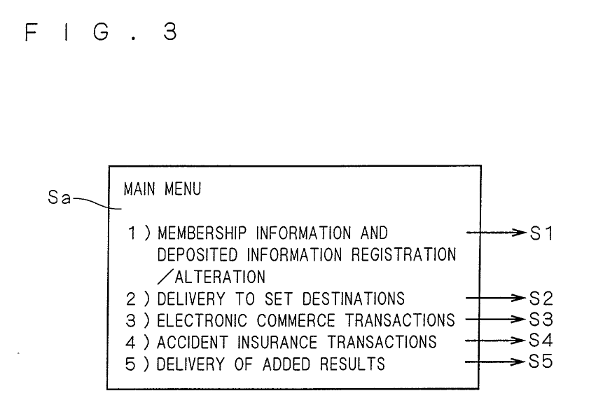

Various processes performed between terminals of the depositor and the like and the depositary's server are now described referring to FIGS. 3 to 11.

First, when the depositor accesses the depositary's server SV from the depositor's terminal DP, the main menu Sa shown in FIG. 3 is displayed in the screen of the depositor's terminal DP. This main menu Sa includes: 1) registration/alteration of membership information and deposited information, 2) delivery to set destinations, 3) electronic commerce transactions, 4) accident insurance transactions, 5) delivery of added results.

When using this information management system for the first time, the depositor makes a contract with the depositary. The form of the contract contents is stored in the contract contents information storage region 21, for example; the depositor fills in the form with necessary items about the contents of the deposit contract and sends it to the server SV, so as to apply for a contract. The depositary checks the contract conditions etc. and approves the application, and thus the contract is settled. The contents of the contract are then recorded in the contract contents information storage region 21.

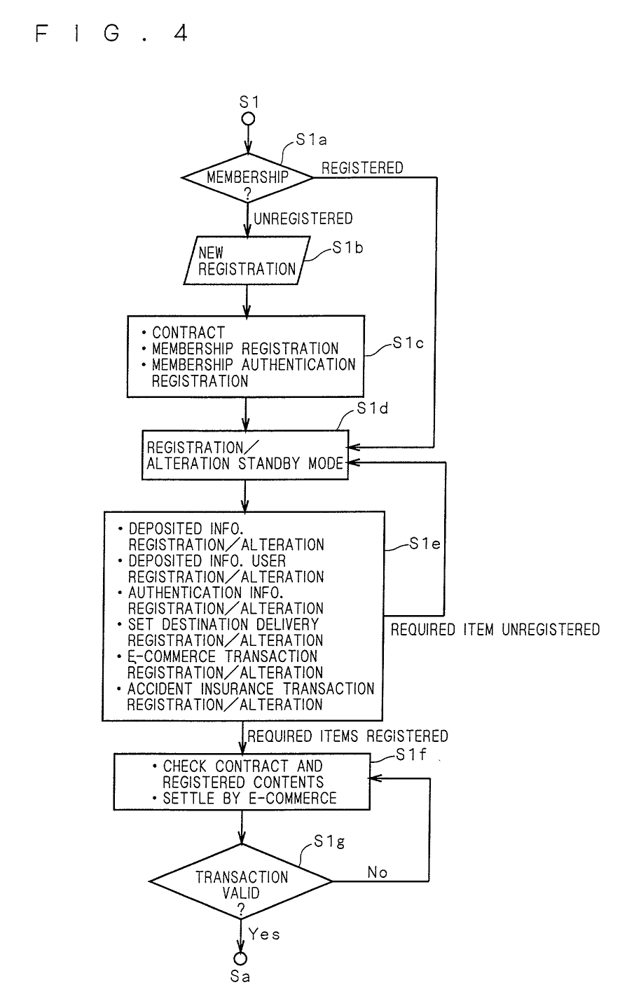

This application for contract is conducted when the depositor selects the item 1) “registration/alteration of membership information and deposited information” in the main menu Sa. That is to say, when this item is selected, the process moves to that shown in FIG. 4, where the control unit 10 first checks whether the depositor who selected the item 1) is already recorded as a member in the membership registration setting information storage region 22 in the storage device 20. More specifically, it asks the depositor for the name, password, etc. and compares the answers with the contents recorded in the membership registration setting information storage region 22 (step S1a).

When it finds no record and judges that this depositor is not registered yet, the flow moves to a process for new registration (step S1b). It then carries out negotiations about contract conditions, membership registration by recording the depositor's name, place to contact, etc., and membership authentication registration by setting a password, membership number, etc. (step S1c). The contents of the membership registration and membership authentication registration are recorded in the membership registration setting information storage region 22.

The control unit 10 then enters a registration/alteration standby mode for the deposited information and the like (step S1d). The flow moves to step S1d also when the membership check in step S1a shows that the depositor is already registered.

The depositor operates the depositor's terminal DP to deposit information stored in the depositor's terminal DP into the server SV. In the server SV, the control unit 10 controls the storage device 20 to record the transmitted information in the deposited information storage region 23 (step S1e). When depositing the information, the control unit 10 sends the aforementioned spending tendency questionnaire to the depositor's terminal and the answers to the questionnaire are included in the deposited information.

Then, as well as the deposited information, the authentication information, deposited information delivery destinations, and electronic commerce information about the deposit contract (account number etc.) are registered. When necessary items are not registered, the control unit 10 returns to the registration/alteration standby mode and prompts the depositor to enter the information. The contents of the authentication information registration are recorded in the authentication information storage region 31.

When the depositary is an agent of the insurance company, a procedure for buying an accident insurance for the deposited information can also be performed in step S1e.

When necessary items have been entered, the control unit 10 checks the contents of the contract and registration and settles the transaction by electronic commerce (step S1f). It then checks whether the electronic commerce has been validly carried out (e.g. whether the credit is enough: step S1g); the flow returns to step S1f when validity is denied and returns to the main menu Sa when the validity is ascertained.

While the flow for new depositor's registration has been described above, the alteration of the registered contents is carried out according to a similar flow. New registration of deposited information users and alteration of registered contents are also similarly conducted.

Next, when the depositor has selected the item 2) “delivery to set destinations” in the main menu Sa, the control unit 10 operates as shown below.

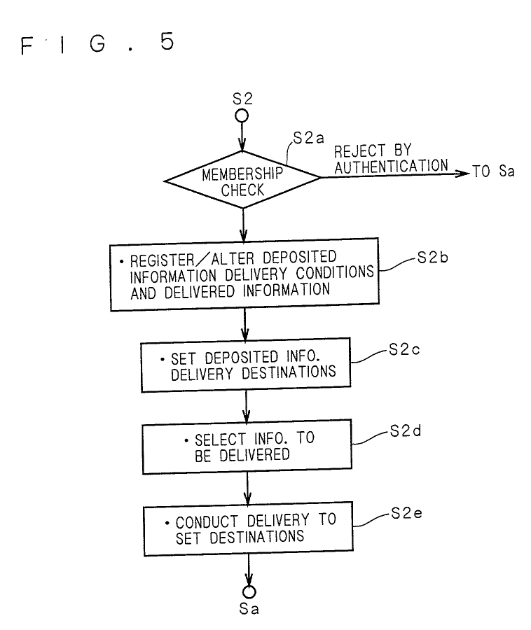

When this item is selected, the flow moves to the process shown in FIG. 5, where, as in the case of the item 1), the control unit 10 checks whether the depositor is already recorded as a member in the membership registration setting information storage region 22 in the storage device 20 (step S2a).

When the check shows that the depositor is already registered, the flow moves to a process of registering the conditions of the deposit information delivery and the contents of information to be delivered. Then the control unit 10 presents a display to the depositor to show that registration/alteration of the deposited information delivery conditions and information to be delivered is now performed (step S2b). The flow returns to the main menu Sa when the depositor is not registered yet.

The depositor operates the depositor's terminal DP to set deposited information delivery destinations (step S2c). Similarly, the depositor operates the depositor's terminal DP to select the contents of deposited information to be delivered (step S2d). The contents of the delivery destination setting process are recorded in the delivery destination selecting process information storage region 41 and the contents of the delivered contents selecting process are recorded in the delivered contents selecting process information storage region 42.

The control unit 10 then carries out the delivery processing on the basis of the entered information about the deposited information delivery conditions and information to be delivered (step S2c). The contents of the delivery process are recorded in the delivery process record information storage region 43. Then the flow returns to the display of the main menu Sa.

Next, when the depositor has selected the item 3) “electronic commerce transactions” in the main menu Sa, the control unit 10 operates as shown below. The electronic commerce transactions are a process which is performed when the depositor desires to increase the capacity or to deposit new information other than that already contracted.

When this item is selected, the flow moves to the process shown in FIG. 6, where, as in the case of the item 1), the control unit 10 checks whether the depositor is already recorded as a member in the membership registration setting information storage region 22 in the storage device 20 (step S3a).

When the depositor is already registered, the flow moves to a process of registering/altering the electronic commerce conditions. The control unit 10 presents a display to the depositor to show that registration/alteration of the electronic commerce conditions is now conducted (step S3b). When the control unit 10 judges that the depositor is not registered yet, the flow returns to the main menu Sa.

The control unit 10 then enters an electronic commerce condition monitoring mode (step S3c). In this mode, every time an item satisfying the electronic commerce conditions takes place, the control unit 10 assesses the transaction (step S3d), determines the price of the transaction (step S3e) and settles the transaction price through electronic commerce (step S3f). This mode is always operating as a background loop; as the foreground job seen from depositor's terminal, the flow returns to the main menu Sa. The fee collection processing is recorded in the fee collection procedure information storage region 51 and the process of the electronic commerce is recorded in the electronic commerce transaction record information storage region 52.

Next, when the depositor has selected the item 4) “accident insurance transactions” in the main menu Sa, the control unit 10 operates as shown below. The accident insurance transactions are a processing which is selected when the depositary is an agent of the insurance company and the depositor desires to newly take out an accident insurance on the deposited information or to change the contents of accident insurance contract settled before.

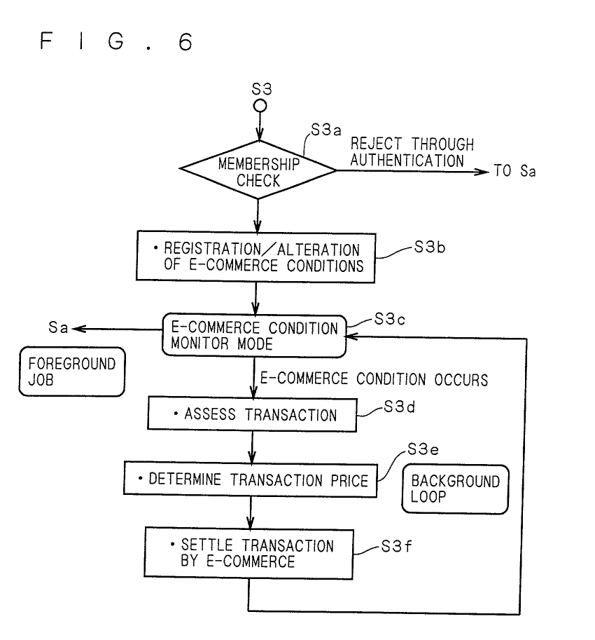

When this item is selected, the flow moves to the process shown in FIG. 7, where, as in the case of the item 1), the control unit 10 checks whether the depositor is already recorded as a member in the membership registration setting information storage region 22 in the storage device 20 (step S4a).

When it judges that the depositor is already registered, the flow moves to the registration/alteration of the accident insurance conditions. The depositor can then register/alter the accident insurance conditions (step S4b). In the case of unregistered, the flow moves back to the main menu Sa.

When the registration/alteration of accident insurance conditions has been finished, the control unit 10 enters an accident insurance condition monitoring mode (step S4c). In this mode, every time an item satisfying the accident insurance conditions takes place, the control unit 10 assesses the damage (step S4d), determines the amount of the accident insurance money (step S4e), and reports the amount of the accident insurance to the depositor and the insurance company (step S4f). This mode is always operating as a background loop; as the foreground job seen from the depositor's terminal, the flow returns to the main menu Sa. The process of the accident insurance transactions is recorded in the accident insurance transaction record information storage region 63.

Next, when the depositor selects the item 5) “delivery of added results” in the main menu Sa, the control unit 10 operates as shown below. This added results delivery is a process in which the answers to the aforementioned spending tendency questionnaire are added up and the added results are delivered to each depositor.

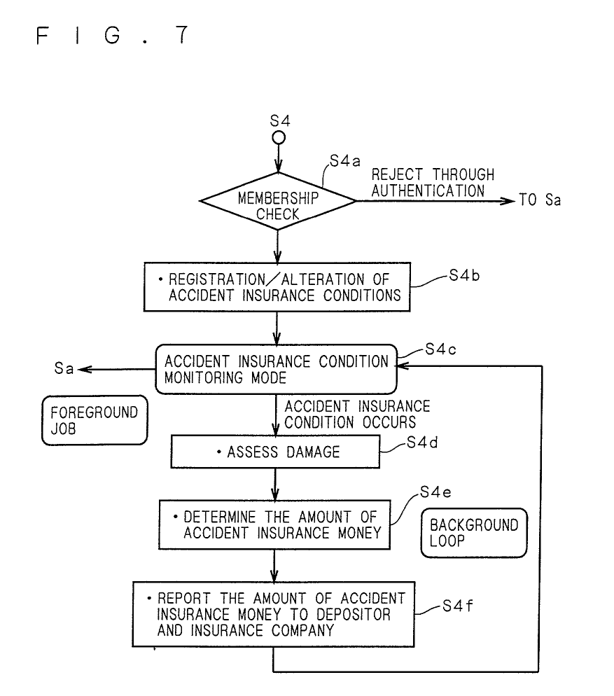

When this item is selected, the flow moves to the process shown in FIG. 8, where the control unit 10 adds up the answers to the questionnaire (step S5a) and sends the added results to each depositor (step S5b). Then the flow returns to the main menu Sa.

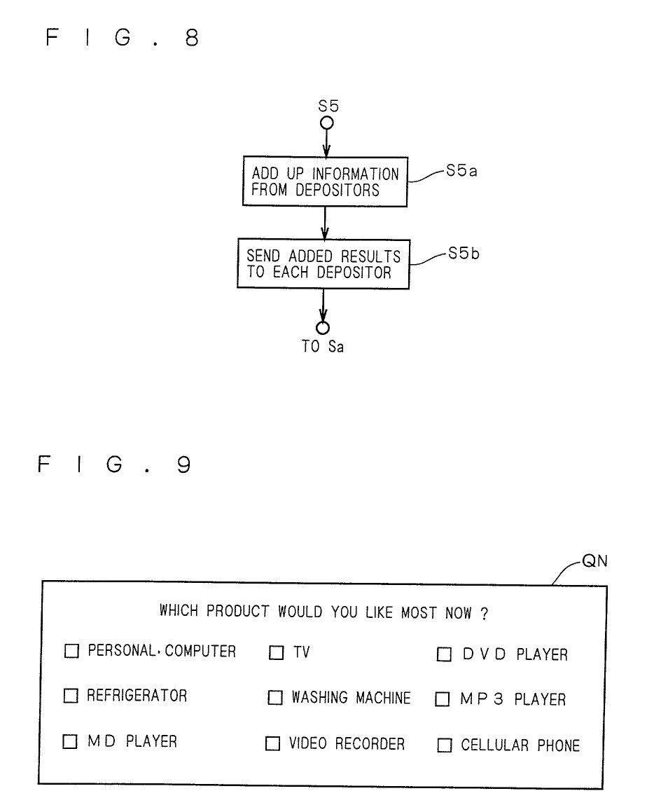

FIG. 9 shows a specific example of the questionnaire. In the questionnaire QN shown in FIG. 9, the depositary asks depositors as consumers “which product would you like most now?” with a plurality of products displayed, and each depositor answers to the question by checking the corresponding check box.

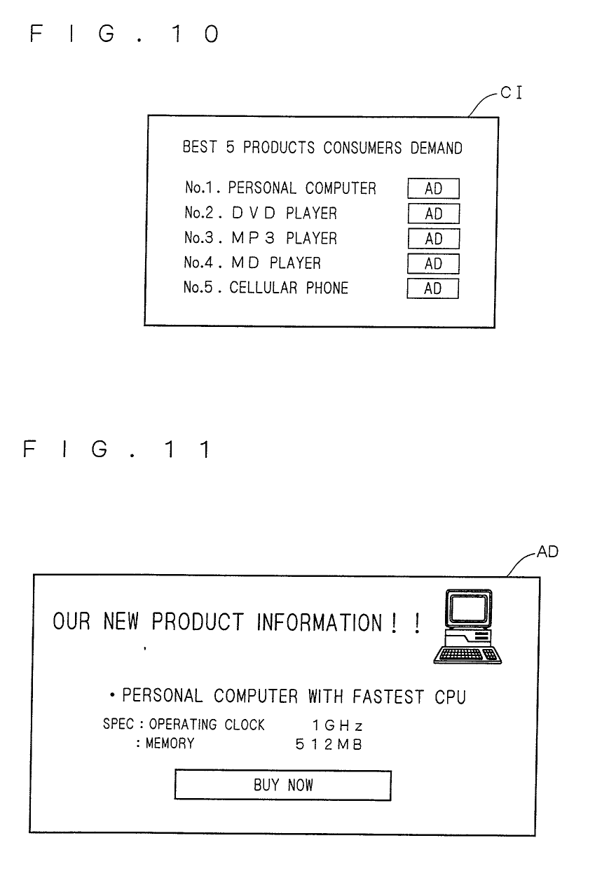

For example, in the questionnaire QN shown in FIG. 9, the control unit 10 adds up the answers to the questionnaire in step S5a by calculating the numbers of checks marked in the individual check boxes. Then, in step S5b, it sends the added results to each depositor in the form of ranking information CI as shown in FIG. 10, for example.

Providing such consumer information as ranking information about products and/or services which depositors demand allows the depositors to consider what products and services to purchase in the future by referring to the products and services many depositors demand.

When the depositors include enterprises and the deposited information includes advertising information about products and/or services they deal with, the depositary can show the advertising information as required from depositors who referred to the consumer information.

More specifically, for example, when the advertising information AD as shown in FIG. 11 is deposited from a company and a depositor selects a sign “AD” in the ranking information CI shown in FIG. 10, the advertising information AD can be displayed on the depositor's terminal.

Further, for example, when the advertising information AD contains a box “BUY NOW” as shown in FIG. 11 and it is linked to the home page of the company, the depositor can select the item and settle electronic commerce with the company about the advertised product.

<Variations>

The preferred embodiment above has shown an example in which deposited information is transmitted to the depositary's server SV from the depositor's terminal DP through the network NT and the consumer information is transmitted from the depositary's server SV to the depositors' terminal DP through the network NT.

However, the depositary's server SV can be used as a stand-alone machine not connected through a network. In this case, the depositor records information in an information medium, e.g. a CD-RW (Compact Disk-ReWritable), brings it to the place where the depositary's server SV is installed, and deposits the information into the depositary's server SV through an input/output interface (not shown) connected to the control unit 10.

Also in this case, when the deposited information is damaged, the server SV assesses the actual loss and calculates the amount of the accident insurance money on the basis of the assessment and the insurance money defining information, so that the amount of the accident insurance money can be quickly calculated and the accident insurance money can be quickly paid to the client.

The process of adding up spending tendency information from the depositors can also be similarly conducted as explained earlier, so that the general tendency information about consumers can be generated and shown to the depositors through an input/output interface (not shown), e.g. a display connected to the control unit 10, thus producing the same effect as those described above.

While the invention has been described in detail, the foregoing description is in all aspects illustrative and not restrictive. It is understood that numerous other modifications and variations can be devised without departing from the scope of the invention.

What is claimed is:

1. An information management device, comprising:
first storage means for storing deposited information which is electronic data deposited by a client;
second storage means for storing insurance money defining information about accident insurance money which, when said deposited information is damaged, is paid as accident compensation to said client on the basis of the extent of said damage; and
control means for controlling said first and second storage means,
wherein said control means calculates the amount of said accident insurance money to be paid for said damage on the basis of said insurance money defining information.

2. The information management device according to claim 1, wherein said control means periodically examines said deposited information to detect said damage.

3. An information management system, comprising:
said information management device according to claim 1;
a terminal of an insurance company which has a contract for said accident insurance money with said client, said terminal of said insurance company being connected to said information management device through a network and capable of conducting electronic commerce; and
a terminal of a financial institution where said client has an account, said terminal of said financial institution being connected to said terminal of said insurance company through the network and capable of conducting electronic commerce,
wherein said accident insurance money is paid from said terminal of said insurance company into said account of said client in said terminal of said financial institution through electronic commerce.

4. An information management device, comprising:
storage means for storing deposited information which is electronic data deposited from a plurality of clients as consumers; and
control means for controlling said storage means,
wherein said deposited information comprises information about spending tendencies of individual said clients, and
said control means is capable of presenting said plurality of clients with consumer information about a general tendency of consumers generated on the basis of said information about spending tendencies.

5. The information management device according to claim 4,
wherein said information about spending tendencies is information about products and/or services which individual said clients demand, and
said consumer information is information about ranking of the products and/or services which said plurality of clients demand and which is obtained by adding up said information about spending tendencies.

6. The information management device according to claim 4,
wherein said storage means also stores another piece of deposited information which is electronic data deposited by another client who is a product and/or service provider, and
said another piece of deposited information comprises advertising information about products and/or services which said product and/or service provider deals with,
and wherein, in response to a request from at least one of said plurality of clients as consumers, said control means presents said advertising information to said at least one of the clients.
